(19) United States
(12) Patent Application Publication
(10) Pub. No.: US 2024/0247174 A1
(43) Pub. Date: Jul. 25, 2024

(54) A LOW FORMALDHYDE-EMISSION ADHESIVE OF UREA-FORMALDEHYDE, USEFUL FOR MANUFACTURING WOODEN BOARD, COMPRISING CELLULOSE NANOFIBERS AND COPPER NANOPARTICLES; METHOD FOR OBTAINING THE SAME

(71) Applicant: UNIVERSIDAD DEL BIO-BIO, Concepción (CL)

(72) Inventor: William Arnoldo GACITÙA ESCOBAR, Concepción (CL)

(21) Appl. No.: 17/256,590

(22) PCT Filed: Jun. 13, 2019
(86) PCT No.: PCT/CL2019/050047

§ 371 Date: May 28, 2021

(30) Foreign Application Priority Data
Jun. 25, 2018 (CL) 1738-2018

(51) Int. Cl. C09J 161/32; A01N 59/20; C08J 5/04; C08J 5/12; C09J 11/04; C09J 11/08

(52) U.S. Cl. CPC C09J 161/32; A01N 59/20; C08J 5/046; C08J 5/124; C09J 11/04; C09J 11/08; C08J 2361/32; C09J 2400/303; C09J 2401/00; C09J 2461/00

(57) ABSTRACT

A low formaldehyde-emission urea-formaldehyde adhesive with superior mechanical properties and high durability, useful for manufacturing wood boards or panels comprising: (a) Urea (U) and Formaldehyde (F) in molar ratio F/U from 0.9 to 1.2; (b) 1.3-1.7% w/w of cellulose nanofibrils (NFC) with a width between 45-60 nm; and (c) 0.4-0.6% w/w copper nanoparticles having a size between 30 to 100 nm, and its method of preparation.

### STATE OF THE ART

The Chilean industry of wood panels has taken a significant role with the purpose to assure a position within a competitive market, looking for an opportunity of providing innovative products according to international standards and taken in consideration the environmental care. Under this scenario, the national production of wood panels, mainly of radiate pine panels, has increased its production from 1,542 thousand of m³ per year in 2002, to 3,170 thousand of m³ per year in 2015. This amount is supported by the growing boom in the development of the building industry and the exportation of products with high added value (INFOR, 2016).

A wood panel is a composite material manufactured with wood fibers, veneers or solid wood with the addition of synthetic resins after a dry applying of pressure and heating. This mixture (wood-adhesive) is adhered by the application of formaldehyde (HCHO)-based curing resins and process of pressure to high temperature with the most advanced technology.

The excellent attributes having these boards are opposed to the current problems which can arise from formaldehyde emissions or free formaldehyde residues from the cured resins used in these panels, which could affect the commercialization of these materials for building and furniture purposes mainly due to restrictions associated to international rules (Ruffing et al 2011), or for the already demonstrated problems which formaldehyde could cause in health of human beings.

It should be considered that the International Agency for Research in Cancer (IARC), a division of the Health World Organization (WHO) re-categorized formaldehyde from “suspicious substance of producing cancer” to a “substance carcinogenic in human beings” (IARC 2005).

Today, it is technologically possible to manufacture low formaldehyde-emission urea-formaldehyde (UF)-type resins or adhesives but it implies a direct reduction of mechanical properties and durability of adhesives and, thus, the board since these are tightly linked to high formaldehyde/urea ratios (F/U) (Esteban Ramirez, Masisa S. A., 2014). The necessity of offering versatile products with costs and appropriate properties, is a driver for searching new technologies.

Several materials have been studied with the purpose of reducing the formaldehyde emission, particularly in urea-formaldehyde-type resins. It has been informed some works that biopolymers containing amyde have been added during the synthesis of the UF resin with the purpose of reducing the formaldehyde emission of a final resin (Just et al 2001, Migneault et al 2011). Also, it has been analyzed the hydrolytic stability of a modified UF resin as a way of reducing the formaldehyde-emission of cured or setting adhesives (Abdullah et al 2009). However, most of the studied modifications, and then, used in the reduction of HCHO emissions, have had a significant reduction of mechanical properties of the adhesive systems (Zhang et al 2011, Dziurka et al 2010, Pan et al 2010, Hse el al 2010). Similarly, it has been carried out studies wherein the use of organic, inorganic and synthetic materials has been remarked to reduce the formaldehyde-emission, which also causes a reduction of the resistance of the adhesive joints in wood. Finally, Laks et al (US6.753.035) discloses a method for incorporating biocides or products based on the same wherein copper nanoparticles are used to improve the fungal properties of wood panels.

None of the solutions or alternative products which have been previously described takes in consideration the problem that formaldehyde emissions represent to the health of human beings.

Together with the technological advances and the high industrial production of wood panels, there is an urgent necessity of delivery in the market a good quality product in accordance with rules and under appropriate manufacture-cost.

### BRIEF DESCRIPTION OF THE DRAWINGS

FIG. 1: corresponds to an atomic force microscopy (AFM) of cellulose nanofibrilles (NFC).

FIG. 2: corresponds to an imagen of a laminated wood panel at laboratory scale with low formaldehyde-emission urea-formaldehyde adhesive.

FIG. 3: corresponds to a graphic of the thermogravimetric analysis to the adhesives.

FIG. 4: corresponds to a graphic of the test sample prepared to the shearing assays of glue lines with the nano copper and NFC-reinforced urea formaldehyde.

FIG. 5: corresponds to an imagen of the test samples after the shearing assay.

### DESCRIPTION OF THE INVENTION

The present technology corresponds to a low formaldehyde-emission urea-formaldehyde adhesive useful for the manufacture of wood panels and the method to preparing them. This adhesive advantageously incorporates nanocellulose and copper nanoparticles conferring superior mechanical properties and high durability, besides a reduction in the free formaldehyde emission achieving up to 60% less emission of formaldehyde in relation to a regular resin as well improving the cohesion forces in the wood panel.

The product accomplishes the international CARB regulation for formaldehyde emissions wherein a HCHO content lower 0.21 mg/m³ is required, besides the Chilean Health Ministry requirements with HCHO emissions lower 0.37 mg/m.

Specifically, this adhesive comprises at least the following components:
a. Urea (U) and formaldehyde (F) at molar ratios F/U=0.9 to 1.2;
b. 1.3-1.7% w/w of cellulose nanofibrils (NFC) having a width between 45-80 nm; and
c. 0.4-0.6% w/w of copper nanoparticles having a size between 30 to 100 nm.

Wood resins or adhesives having a strong adhesion to a cellulose matrix then cellulose nanofibrils are a very proper material and compatible to reinforce the adhesives. On the other hand, the addition of copper nanoparticles to the adhesives confer in a direct way on the properties of resistance to fungal or insect attacks and directly impact in the to productivity and final quality of wood panels since the same allows a reduction in the curing time of the adhesive due to a better thermal conductivity in the resin and the wood panel.

The method for manufacturing of the low formaldehyde-emission adhesive comprises at least the following steps:

a.

To avoid changes mechanical and fungal properties of the low formaldehyde-emission urea-formaldehyde adhesive is must be maintained at −4° C., until its application in wood panels manufacturing.

Advantageously, this reinforced adhesive with a natural filler of high resistance causes a reinforcement effect in the polymer matrix (functioning as a compound), this is without adding chemical additives into the adhesive mixture. Said mixture presents appropriates ratios of its components allowing the generation of a low HCHO-emission wood panel and with an increase in fungal and mechanical properties, compared to standard low-emission wood panel but with very low mechanical properties, intrinsic condition for low crosslinking-grade polymers associated to the low molar ratio of these adhesive systems. For the reinforced adhesive, the fungal properties resulting 100% effectives to protect against termites.

### EXAMPLES OF APPLICATION

### Example 1: Method for Obtaining NFC

Cellulose nanofibrils (NFC) are obtained by a mechanical pulp treatment according to methodologies described by Junka et al (2014) and Nair et al (2014). A white Kraft Pulp was milled using a IKA knife mill (MF 10 basic W. Reichmann) at 3,500 rpm, provided by a sieve of 1.0 mm of diameter fed of continuous wood, this procedure allows reduction of the fiber size during the mechanical treatment.

Then, the milled Pulp was diluted in distilled water at a consistency of 5% w/w during 12 h; then, NaOH 0.5% w/w (NaOH prepared at 5% w/v) is added with the purpose of swelling the fibers to improve its separation during the disintegration. After swelling, the mix fibers-water were mechanically disintegrated using a SuperMassColloider (MKCA6-25, Masuko Sangyo Co., Ltd, Japón) colloidal mill at 1,500 rpm. Pulp was continuously processed during 2 h in the mill. This equipment consisting on two stone milling discs, adjusted therebetween to a separation of 0.5 μm, further determining the presence of pulp in discs to ensure a clean milling without presence of contaminant residues in the sample. Then, the processed diluted fibers were carried out to a consistency of 1% w/w using distilled water and homogenizing the sample in a IKA ULTRA-TURRAX® (model T25) digital equipment provided with a supplier accessory (model: S25 N25 GST, System: rotor/stator, maximum separation rotor/stator: 0.5 mm). The dispersion is performed at a velocity of 12,000 rpm during 5 min. Then, the homogenized sample was processed into a Microfluidizer (Microfluidizer model LM-10), which operated to a constant pressure of 1,000 bar and at temperature of 18 to 25° C. To obtaining nanofibrillated cellulose (NFC), samples were passed during successive 9 times, obtaining a 100% yield to the process.

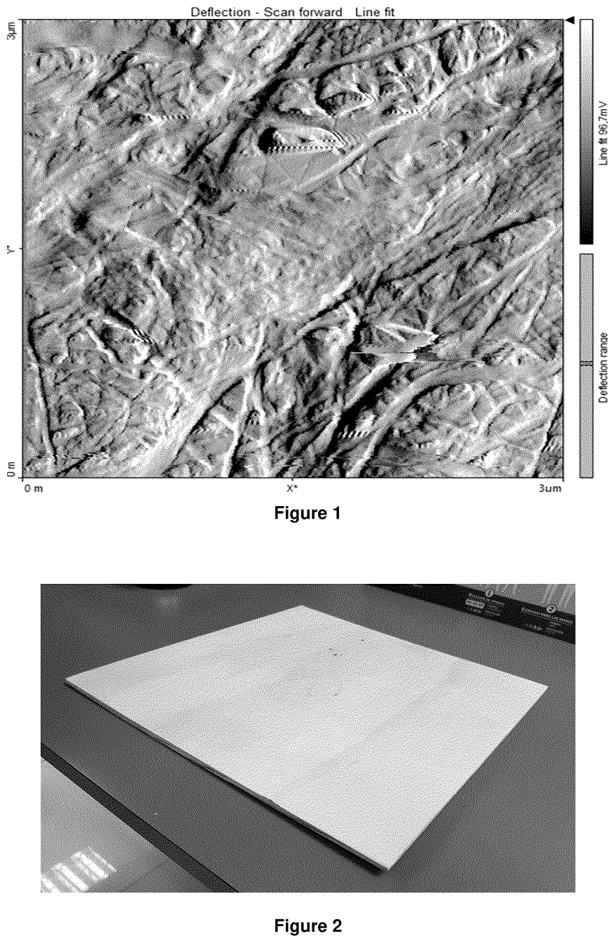

Finally, to achieve NFC under anhydro status and with a fine granulometry (1 mm approximate), the samples in suspension were centrifugated, freeze-dried and milled. The centrifugate of the suspension was performed with the objective of eliminating the maximum amount of water present in the NFC up to obtaining a gel. This procedure was performed in a centrifuge YINGTAI (instrument High Speed Refrigerated Centrifuge), model GL21M with rotor to 6 tubes, operated at 12,000 rpm during 30 min at 8° C. Then, the freeze-drying of the simples is carried out using a freeze-drying equipment CHRIST BETRA 1-8 LD. Then, the NFC gel obtained was frozen during 24 h at temperature of −56° C. and barometric pressure of −0.016 mbar, up to eliminating approximately 99% of moisture presents in the sample. The NFC under anhydro state was milled using a IKA (MF 10 basic, WReichmann) knife milling at 3,500 rpm, which was equipped with a sieve of 1.0 mm of diameter, fed in a continuous way. Ended this process, the NFC were stored in bags with hermitic closure at room temperature. FIG. 1 shows an image of atomic force microscopy (AFM) of the obtained cellulose nanofibrils (NFC).

### Example 2. Method for Elaborating a Low Formaldehyde-Emission Urea-Formaldehyde Adhesive

The process to elaborate the low emission adhesive comprising the following steps:
a. Conditioning the adhesive: using an analytic balance was massed and located 100 g low (HCHO) emission-UF adhesive with 60% adhesive solid, emission with a ratio F/U of 0.9/1.2 in a precipitating container of 500 mL. Then, the sample was conditioned at 25° C. using a thermostatic bath during 20 min.
b. Addition of copper nanoparticles: 0.5% w/w copper nanoparticles (0.3 g) was added to the glass container.
c. Homogenization: the mixture of step (b) was added into a homogenizer Ultraturrax at a constant speed of 14,000 rpm during 5 min. The excessive increasing temperature caused by the mechanical stirring was controlled by a thermocouple.
d. Addition of NFC: 1.5% w/w NFC under metallic stated was added to the homogenizer and produced by mechanical treatment (0.9 g), which were dispersed at a speed of 14,000 rpm during 5 min.

The prepared adhesives were refrigerated at −4° C. to avoid changes in the initial properties.

Prior its use in wood panels, the adhesive was conditioned at 25° C.

The significance of the adhesive mixture to the use in the production of wood panels fundamentally lies in the ratio added of NFC and copper nanoparticles, this is in terms of the contributions to attributes of the final product, wherein improvements to the wood panels are associated to the properties of low HCHO emissions and an increase in the mechanical and fungal properties of the wood panel.

### Example 3: Manufacture of Laminated Wood Panels from a Low Formaldehyde-Emission Urea-Formaldehyde Adhesive

To verify the low emission of the copper nanoparticles and NFC-based adhesive, prepared as describe in example 2, 2 commercial urea-formaldehyde (UF)-based adhesive systems based on urea-formaldehyde (UF) of low and high HCHO emission were used as control; these adhesives are currently used in manufacturing particleboards and fiberboards.

Specifically, C1 was used as control of low HCHO emission and C2 was used as control for high HCHO emission.

To prepare the wood panel at lab scale by triplicate, knot-free wood veneers of Pinus radiata D. Don., with 8% moisture and dimensions of 2.6 mm thickness×400 mm width×400 mm length were used.

Firstly, wood veneers were selected from a visual way, and then, dried in stove at 60±2° C., up to achieving an average equilibrium moisture of 8%. During the process, the moisture of veneers was controlled by means of a xylohygrometer according Chilean standar NCh.176/1 Of.86. Veneers after dried are conditioned at 35±2° C. and stored at 23±2° C. Then, using a grammage of 160 g/m² per each adhesive system; the adhesive was applied on the side of a first veneer conforming the board, spreading under homogeneous way with the aid of a rubber roller, to then assembly with a second veneer without adhesive. The total assembly time was approximately 5 min up to achieve a stickiness in the adhesive.

After the assembly, wood panels were pre-pressed applying a specific pressure of 5 bar during 3 min at room temperature and then subjected to hot pressing using a plate press trademark Dumont, at 130° C. and with a total press cycle of 350 seconds, at a pressing factor of 1.1 min/mm. The general room conditions achieved during the manufacture of the boards were 22° C. temperature and 57% relative humidity.

After ended the pressing, wood panels were stored in polyethylene containers during 4 days at normal temperature conditions. After this time, wood panels were cut to final dimensions of 350 mm width×350 mm length using a squaring circular saw. FIG. 2 shows an example of the manufactured wood panels.

### 3.1.—Validation of the Manufactured Adhesive Systems.

### 3.1.1. Determination of HCHO Emissions:

Validation runs were performed to the nanoparticle-reinforced adhesive system denominated A1, corresponding to a low HCHO-emission adhesive+1.5% NFC and 0.5% NanoCu, and A2 corresponding to a high HCHO-emission adhesive+1.5% NFC and 0.5% NanoCu. These samples were contrasted with control C1 and C2.

After determination of HCHO emissions, the control adhesives showed values of 1.18 and 2.38 mg/L for C1 yC2, respectively. These analyses were performed under the standard JIS A-1460:2001 “building boards determination of formaldehyde emissions: Desicator method”, and permissible heaty were analyzed according to the annex of the standard JAS—223: 2003. HCHO emissions to the nanomaterial-reinforced adhesives showed values of 0.71 and 1.95 mg/L to A1 and A2, respectively. In both cases, low and high emissions, it was observed a clear reduction in the HCHO emission indicating a significant attribute for the subsequent wood panels.

### 3.1.2. Thermo-Mechanical Analysis (DMA) for the Adhesives:

In this analysis, the minimal and maximum curing temperature was verified, obtaining the results detailed in Table 1

TABLE 1

| | Minimal curing | Maximum curing |
|---|---|---|
| Adhesive | Temperature (° C.) | Temperature (° C.) |
| Control C1 | 76.9 | 195.7 |
| Control C2 | 74.7 | 211.0 |
| Adhesive A1 | 72.5 | 188.8 |
| Adhesive A2 | 71.6 | 205.4 |

For the two reinforced adhesives there was a reduction to the minimal curing or setting temperature as well to the maximum curing temperature, thus the energy used to cure or thermosetting was lower compared to controls, which increase the productivity of wood panels, reducing the pressing time in an industrial plant. Particularly, it was verified that curing temperatures for the adhesive with 1.5% NFC and 0.5% nanocopper started and ended at 72.5° C. and 188.8° C., respectively. The same adhesive without additives started and ended its curing at 76.9° C. and 197.7° C., respectively. This confirm that the addition of copper nanoparticles in the adhesives indirectly impacted on the manufacture and final quality of wood panels since the curing time was reduced due to a better thermal conductivity of the resin and then in the wood panel.

### 3.1.3. Thermogravimetric Analysis (TGA)

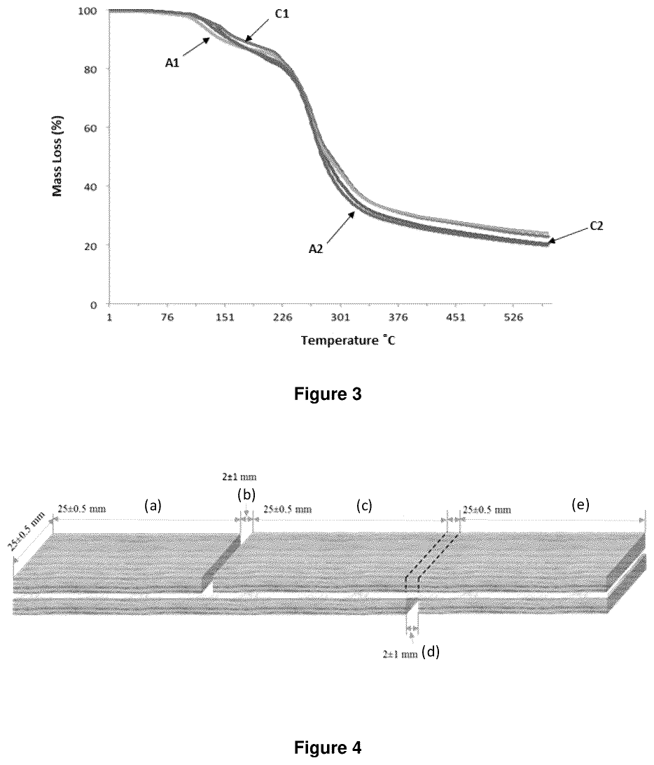

Control adhesives showed a mass loss of 76.5% for C1 and 79.6% for C2 and for the nanoparticles-reinforced adhesives the mass loss was 76.1% for A1 and 80.1% for A2, at a temperature of 600° C. This confirms that the addition of particles (NFC and Cu) at the original system does not cause adverse effects, keeping its properties, especially in the thermal structure of the new reinforced adhesive, which can be confirmed in the TGA of FIG. 3.

### 3.1.4. Analysis of Shear Resistance in Laminated Boards

For control adhesives the test showed values of shear of 2.46 and 2.61 N/mm², to C1 and C2, respectively. In the reinforced adhesives the values were of 3.00 for A1 and 2.45 N/mm² for A2. These results show a great potential for the low HCHO emission adhesive to be reinforced with nanomaterials since the shear value of a manufactured wood panel increases. According to the standard UNE EN-314-1 (1993) the shear resistance in laminated wood panels, and the addition of nanofibers and nanoparticles, there was a significant increase of this property (22% increase).

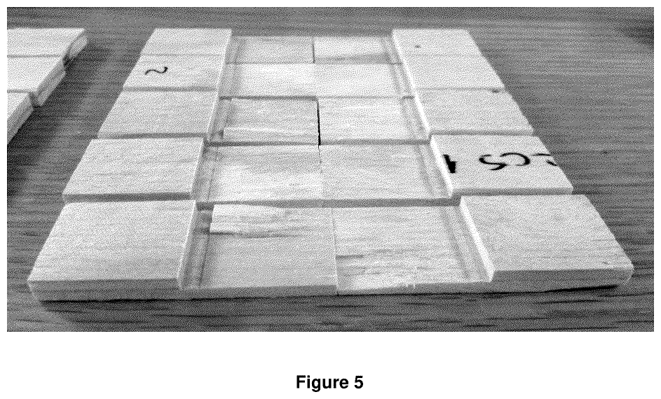

FIG. 4 shows shear test sample cut in parallel to the wooden fibers in a laminated, wherein (a) corresponds to the jaw clamping area; (b) a saw cut; (c) shear test sample; (d) a saw cut; and (e) jaw clamping area. This is according to the standard UNE EN 314. Similarly, FIG. 5 shows the same sample after shearing test.

### 3.2. Determination of Fungal Properties of the Adhesive

To evaluate this adhesive property, wood panels samples, containing termites inside were analyzed. On table 2, is showed the level of termite attack to the samples of particleboards manufactured with the adhesive system with and without reinforce, compared to the attack of a control test sample of Pinus radiata; the test was performed under the Chilean standard NCh 3060.

TABLE 2

| | Test Sample | Survival (No. individual) | | | Grade of |
|---|---|---|---|---|---|
| Treatment | No. | O | N | S | attack |
| Treated | X | 0 | 0 | 0 | 1 |
| | Y | 0 | 0 | 0 | 2 |
| | Z | 0 | 0 | 0 | 3 |
| | Average | 0 | 0 | 0 | 2.7 |
| Non Treated | A | 40 | 0 | 2 | 3 |
| | B | 80 | 1 | 1 | 3 |
| | C | 57 | 1 | 1 | 4 |
| | Average | 59 | 1 | 1 | 3.3 |
| Non-treated | a-1 | 128 | 2 | 2 | 4 |
| Pine Witness | b-2 | 160 | 4 | 2 | 4 |
| | c-3 | 135 | 3 | 3 | 4 |
| | Average | 141 | 3 | 2 | 4 |

Fungal properties reinforced adhesives, resulted as very efficient since in the assays against termites the protection on the wood panel was 100% effective as opposed to wood panels made with adhesives without copper nanoparticles; here termites caused degradation to the particleboard samples.

1.- A low formaldehyde emission urea-formaldehyde adhesive, useful for manufacturing of wood boards or panels comprising at least of the following components:
a. Urea (U) and Formaldehyde (F) in a molar ratio F/U from 0.9 to 1.2;
b. 1.3-1.7% w/w cellulose nanofibrils (NFC) with a width between 45-60 nm as a reinforcement of an adhesive; and
c. 0.4-0.6% w/w copper nanoparticles (NPC) having a size between 30 to 100 nm, acting to the fungal repelling insect attack.

2.- A method to prepare a low formaldehyde-emission adhesive of claim 1, comprising at least the following steps:
a. Conditioning the adhesive, by adding into a vessel having a thermostatic bath a molar ratio of 0.9/1.2 formaldehyde/urea, which is conditioned at a temperature between 20-30° C. during 20 min.
b. Adding copper nanoparticles: 0.4-0.6% w/w of copper nanoparticles, determined based on the solids of the urea-formaldehyde adhesive, which is added into the vessel.
c. Homogenization: the mixture of the step (b) is homogenized at constant velocity between 12.000-16.000 rpm during 3-7 min, at room temperature.
d. Addition of NFC: 1.3-1.7% w/w NFC, is added into a homogenizer, which are dispersed to a velocity between 12.000-16,000 rpm during 3-7 min
